(19) United States
(12) Patent Application Publication
(10) Pub. No.: US 2007/0051887 A1
(43) Pub. Date: Mar. 8, 2007

(54) Cantilever and inspecting apparatus

(76) Inventors: Kishio Hidaka, Hitachiota (JP); Motoyuki Hirooka, Hitachi (JP); Mitsuo Hayashibara, Hitachinaka (JP); Tadashi Fujieda, Mito (JP); Hiroki Tanaka, Takahagi (JP); Noriaki Takeshi, Mito (JP); Takafumi Morimoto, Kashiwa (JP); Satoshi Sekino, Ushiku (JP); Masato Takashina, Mito (JP); Yuki Uozumi, Hitachinaka (JP)

Correspondence Address: MCDERMOTT WILL & EMERY LLP, 600 13TH STREET, N.W., WASHINGTON, DC, 20005-3096, US

(21) Appl. No.: 11/513,411

(22) Filed: Aug. 31, 2006

(30) Foreign Application Priority Data
Aug. 31, 2005 (JP) 2005-251767
Mar. 23, 2006 (JP) 2006-080267

(51) Int. Cl. G21K 7/00

(52) U.S. Cl. 250/309

(57) ABSTRACT

The present invention provides a cantilever having a base fixed to an inspecting apparatus, a beam protruding from the base, and a probe fixed to an end of the beam, wherein: the probe is formed by use of a carbon nanotube; and the probe is fixed by metal layers from at least two directions when the cantilever is operated, the probe protrudes in a direction in which a sample is fixed. It is possible to prevent the probe from warping and suppress image failures during observation of a sample.

### CLAIM OF PRIORITY

The present application claims priority from Japanese application serial No. 2005-251767, filed on Aug. 31, 2005 and Japanese application serial No. 2006-080267, filed on Mar. 23, 2006, the contents of which are hereby incorporated by references into this application.

### BACKGROUND OF THE INVENTION

1. Field of Technology

The present invention relates to a cantilever that uses a carbon nanotube as a probe and to a method of manufacturing the cantilever. The invention also applies to an LSI inspecting apparatus and a lithography apparatus that uses the inventive cantilever.

2. Background of Art

An atomic force microscope (AFM) is a type of scanning probe microscope (SPM). An exemplary AFM is an apparatus in which a cantilever having a sharp probe is mounted and the cantilever probe is brought into contact with a sample to scan the sample, thereby measuring a surface of the sample. A feedback mechanism that raises and lowers the cantilever or sample is provided so as to keep a constant state when the cantilever probe is brought in contact with the sample. Accordingly, a surface state (unevenness, for example) can be measured from control signals. Other SPMs include a scanning tunnel microscope and scanning near-field optical microscope.

The carbon nanotube is a cylindrical column with a high aspect ratio and a constant diameter. An angle formed by the sample surface and the diameter at the tip of the probe that touches the sample does not change even when the tip of the probe being used is worn or scratched. Accordingly, when a cantilever that uses a carbon nanotube as a probe is used in an AFM or an SPM that includes an AFM, superiority (in thickness) is provided in that a spatial resolution is maintained.

In a conventional method of manufacturing a cantilever with a carbon nanotube, hydrocarbon impurities existing inside a scanning electronic microscope are radiated with electron beams so that the impurities are deposited near the carbon nanotube, thereby fixing the carbon nanotube to a substrate, as described in Patent Publication No. 3441396 (Japanese Application Patent Laid-open Publication No. 2000-227435) (Patent Document 1) and Patent Publication No. 3441397 (Japanese Application Patent Laid-open Publication No. 2000-249712) (Patent Document 2). According to Japanese Application Patent Laid-open Publication No. 2002-162337 (Patent Document 3), to fix a carbon nanotube to a cantilever, the carbon nanotube is placed on the cantilever and hydrocarbon present inside the scanning electronic microscope is radiated with electron beams so that the hydrocarbon is deposited on the carbon nanotube. In Patent Document 3, focused ion beam machining is performed to fix the carbon nanotube probe attached to the cantilever. In another method described in Japanese Application Patent Laid-open Publication No. 2003-90788 (Patent Document 4), a catalytic metal film is formed on the cantilever; the catalytic reaction is used to form a carbon nanotube on the cantilever. This method cannot be expected to provide conductive characteristics as desired for metal because the catalytic metal changes into a supersaturated solid solution of carbon, resulting in a carbide. In Japanese Application Patent Laid-open Publication No. 2005-62007 (Patent Document 5), a pyramid-shaped holder of the cantilever is dipped in an organic solvent to form a carbon nanotube. In Japanese Application Patent Laid-open Publication No. 2005-63802 (Patent Document 6), a highly resistive surface layer formed on a surface of the holder, such as natural oxide film, is removed before the carbon nanotube is metal-joined, reducing the resistance.

Patent Document 1: Patent Publication No. 3441396 (Japanese Application Patent Laid-open Publication No. 2000-227435)

Patent Document 2: Patent Publication No. 3441397 (Japanese Application Patent Laid-open Publication No. 2000-249712)

Patent Document 3: Japanese Application Patent Laid-open Publication No. 2002-162337

Patent Document 4: Japanese Application Patent Laid-open Publication No. 2003-90788

Patent Document 5: Japanese Application Patent Laid-open Publication No. 2005-62007

Patent Document 6: Japanese Application Patent Laid-open Publication No. 2005-63802

### SUMMARY OF THE INVENTION

There are various modes for operating an AFM to detect the state of a sample surface; for example, the cantilever or sample is raised and lowered in such a way that the probe discontinuously comes into contact with the surface of the sample under a preset constant approach load (step-in mode), the probe continuously or discontinuously traces the surface of the sample with the probe in contact with the sample surface (contact mode), and the cantilever is forcibly vibrated to strike the sample surface and changes in the amplitude, phase, frequency of the vibration are measured (dynamic mode). A suitable mode is selected according to the sample and the state of the sample surface. If a carbon nanotube is used as the probe in these operation modes, a buckle and bend of the carbon nanotube cause a problem. A bend of the carbon nanotube indicates a state in which the carbon nanotube is curved due to a horizontal force applied to the carbon nanotube, and a buckle indicates a horizontal bend that is caused abruptly at the instant when a certain buckle load is reached after a vertical approach load is applied to the carbon nanotube.

To detect the above approach load, the so-called optical lever method is generally used to detect an amount of warp of the cantilever. Accordingly, a spring constant of the cantilever that is enough to detect the amount of warp is selected.

If an excessive approach load is set for the carbon nanotube probe in the modes described above, a bend or buckle is caused when the carbon nanotube comes into contact with the sample. This prevents the state of the sample surface from being detected correctly. Accordingly, an image obtained as a measurement result, which should represent the state of the sample surface, represents a shape different from the intrinsic surface shape; the carbon nanotube probe is released from the cantilever, disabling measurement from being continued, and other problems occur.

To suppress a buckle, the approach load of the cantilever must be smaller than the buckle load at which the carbon nanotube causes a buckle. At the same time, the spring constant of the cantilever must be such that the approach load is enough to cause a warp as described above. When the strength of the entire cantilever and its material are considered, it is difficult to lower the current spring load of the cantilever. In particular, in the dynamic mode, the cantilever is vibrated at a high frequency; when the spring constant is lowered, therefore, the measurement accuracy may be lowered. Therefore, the buckle load of the carbon nanotube must be large.

To suppress a bend, a small approach load must be set for the cantilever so that the horizontal force applied to the carbon nanotube falls within the range in which the measurement accuracy is not affected. At the same time, the spring constant of the cantilever must be such that the approach load is enough to cause a warp as described above. When the strength of the entire cantilever and its material are considered, it is difficult to lower the current spring load of the cantilever. Therefore, the strength of the carbon nanotube against a bend must be high.

An object of the present invention is to provide a cantilever equipped with a carbon nanotube probe that is hard to buckle and has a high strength against a bend, as well as a detecting apparatus, AFM, and further SPM that use the cantilever.

According to the present invention that addresses the above problems, an end of a carbon nanotube is fixed to an end of a holder by use of metal layers from at least two directions and the metal layers are deposited in an arbitrary range on the carbon nanotube. Since the metal layers are deposited from the two directions, the exposed range of the carbon nanotube can be adjusted, thereby suppressing a buckle and a bend.

The present invention also provides a manufacturing method by which metal layers are deposited at the end of the cantilever to which the carbon nanotube probe is fixed from at least two directions.

In another aspect of the present invention, a cantilever probe is formed by use of a carbon nanotube including heteroatoms. Particularly, a carbon nanotube including nitrogen or boron is preferable. The content of heteroatoms is preferably 2 to 5 atomic percent. Another aspect of the present invention is the method of using a cantilever including a probe formed by use of a hetero carbon nanotube, in which the cantilever is brought into contact with a surface of a sample with a pressing force of 20 nN or less.

The metal layer described above is formed by discomposing a metal compound gas through electron beam radiation and depositing a product. Specifically, the metal layer is formed by using tungsten (W), platinum (Pt), aurum (Au), aluminum (Al), copper (Cu), molybdenum (Mo), or the like. Particularly, the metal layer is preferably a tungsten joint layer. This is because the use of a metal layer, particularly a tungsten layer, increases the joint strength as compared with a hydrocarbon adhesive. Another reason is that since a metal layer is used for joining, conductivity is provided between the carbon nanotube and cantilever and thus the destruction of the joining portion, which is considered to be caused by the effect of charges, can be avoided. A higher purity of the metal layer is more superior, but a content of 70% or more assures sufficient fixing.

The joining described above is achieved by an apparatus for manufacturing a cantilever with a carbon nanotube, the apparatus having a sample chamber under vacuum or a reduced pressure into which the cantilever and carbon nanotube are placed, a gas supplying unit for supplying gaseous tungsten hexacarbonyl (W(CO)₆) or tungsten fluoride (WF₂) used as a source of a metal layer, which has been heated and vaporized, and an electron beam radiating unit for radiating electron beams to discompose the gas.

An example of a product that uses the above cantilever is a scanning probe microscope. The scanning probe microscope uses a cantilever having a probe to detect the state of a sample surface. The scanning probe microscope can be used as a semiconductor inspecting apparatus, a digital versatile disk (DVD) pit detecting apparatus, an aberration-free lens inspecting apparatus for charge coupled device (CCD) cameras, a roughness gauge, a bio-observation apparatus, or a non-destructive observation apparatus for high polymers. The present invention is also an LSI chip manufacturing apparatus in which the above scanning probe microscope is used as an inspecting apparatus. Other names such as a manipulator and CD-AFM may be used to refer to the scanning probe micrometer.

Another product example is an LSI inspecting apparatus. The LSI inspecting apparatus comprises a cantilever, a contact detector for detecting that an LSI chip under test touches the probe of the cantilever, a Z-axis servo circuit for the LSI chip under test, which feeds back signals from the contact detector, an XY scanning circuit for obtaining two-dimensional surface information of the LSI chip under test, a central processing unit (CPU) for receiving signals from the Z-axis servo circuit and the XY scanning circuit, and a display unit for displaying an image according to the signals received by the CPU. The probe of the cantilever is configured by the carbon nanotube probe described above. The cantilever probe is preferably formed by use of a hetero carbon nanotube including heteroatoms, particularly, a hetero carbon nanotube including nitrogen or boron.

An LSI chip is manufactured by the following steps: (i) a semiconductor, a metal conductive layer, or oxide and nitride insulating layers are laminated on a substrate by a chemical vapor deposition method, (ii) part of the laminate is etched so that a cross section is exposed, (iii) the above LSI inspecting apparatus is used after the etching process to inspect the surface shape, and (iv) these processes are repeated several times, thereby producing highly precise LSI chips.

Another product example is a lithography apparatus. The lithography apparatus comprises a cantilever having a hydrophilic probe, a lithography power supply unit for electrically connecting the cantilever to a sample base on which a sample under test by the lithography apparatus is placed, a contact detector for detecting that the sample under test touches the probe of the cantilever, a Z-axis servo circuit for the sample under test that feeds back signals from the contact detector, an XY scanning circuit for obtaining two-dimensional surface information about the sample under test that has been anodized by passing current through absorbed water generated on a contact between the sample under test and the probe of the cantilever, a CPU for receiving signals from the Z-axis servo circuit and the XY scanning circuit, and a display unit for displaying an image according to the signals received by the CPU. The probe of the cantilever is configured by the carbon nanotube described above.

The cantilever probe is preferably formed by use of a hetero carbon nanotube including heteroatoms, particularly, a hetero carbon nanotube including nitrogen or boron.

An LSI chip is a circuit in which many transistors and other devices are integrated. Particularly, the circuit is formed by repeating the following three steps: (1) chemical vapor deposition, (2) etching, and (3) surface inspection. After the above etching, the inspecting apparatus described above can be used to inspect in detail the state of a surface of an LSI chip being fabricated.

According to the inventive cantilever with a carbon nanotube and the inventive method of manufacturing the cantilever, the stiffness of the probe is increased, so the probe is hard to warp when the probe is pushed against a sample. Accordingly, the precision of image data provided by the LSI inspecting apparatus and lithography apparatus can be increased. This addresses problems caused during measurement by use of an AFM in which a cantilever with a carbon nanotube is used, due to a bend or buckle of the carbon nanotube; the problems are, for example, that an image that represents a shape different from the intrinsic surface shape of the sample is obtained as a result of measurement, the joining portion of the carbon nanotube is destructed by charges, and image failures occurs. Therefore, stable AFM-based measurement can be performed.

Accordingly, an atomic force microscope that enables highly precious measurement with a high resolution can be achieved by taking advantage of the fact that the carbon nanotube described above is thin.

In addition, since the life of the cantilever can be prolonged, highly precious, stable measurement with a high resolution can be practiced for a long period of time. This enables manufacturing of products, such as LSI chips, that need highly precious shape measurement (inspection process) in the course of manufacturing.

### BRIEF DESCRIPTION OF THE DRAWINGS

FIG. 1 is a perspective view of a cantilever representing an embodiment of the present invention.

FIG. 2 is a schematic diagram representing an atom array of the probe of the cantilever.

FIG. 3 is a force curve drawing of the probe when a probe warp is generated.

FIG. 4 is a force curve drawing of the probe when the probe of the present invention is used.

FIG. 5 is a perspective view of the probe disposed at one end of the cantilever representing an embodiment of the present invention.

FIG. 6 is a schematic diagram of the cantilever representing an embodiment of the present invention.

FIG. 7 is a cross-sectional view at the end of the cantilever in FIG. 5.

FIG. 8 shows an analysis result of gradients in a tungsten-doped metal layer.

FIGS. 9A to 9D show consecutive AFM images obtained when the cantilever having a carbon nanotube fixed with carbide layers is brought into contact with a sample.

FIG. 10 is a schematic diagram of the structure of an LSI inspecting apparatus representing an embodiment of the present invention.

FIG. 11 is a schematic diagram of the structure of a lithography apparatus representing an embodiment of the present invention.

### DETAILED DESCRIPTION OF THE INVENTION

The cantilever according to the present invention will now be described in detail.

An inspecting apparatus such as an AFM has a cantilever that comprises a base part, a beam extends from the base part and warps according to the approach load, and a probe fixed to the end of the beam. The cantilever is fixed to the main body of the AFM. The probe in the present invention is formed by use of a carbon nanotube. A holder used as a base to fix the probe may be provided at the end of the cantilever, if necessary. Approximately directions of the cantilever and probe can then be set with ease.

As described above, in the present invention, metal layers are deposited from at least two directions and a carbon nanotube is fixed at an end of the cantilever or holder, the end facing the sample during measurement. The above two directions must be such that the carbon nanotube at the end can be held at an arbitrary direction. Preferably, the two directions oppositely face each other. In two exemplary opposite directions, metal layers may be deposited in two places at the root of the carbon nanotube (at the end of the cantilever or holder) at intervals of about 180°. Metal layers may also be deposited in three places at intervals of 120°.

The holder may have a shape such as a pyramid, polyhedral cone, circular cone, or cylindrical column. The end of the holder may be shaped into a needle. When the holder is a cone, the carbon nanotube is preferably fixed at the tip of the holder by depositing a metal layer from an arbitrary direction and then a second metal layer is preferably deposited on the back (diametrically opposite) of the carbon nanotube to fix the holder, facilitating the fixing process and keeping the carbon nanotube in the same place. To achieve the two opposite directions, the worker may invert the cantilever about 180° to deposit the second metal layer. Since metal layers are deposited from a plurality of directions, if, for example, the carbon nanotube is bent while a first metal layer is being deposited, the bent end can be adjusted by depositing a second metal layer. Therefore, the probe can be fixed with ease with its angle adjusted. This is also true when the end of the cantilever is machined to a shape similar to the shape of the holder.

The two directions described above will be specifically described.

A plane of the sample base and the probe must be capable of forming an arbitrary angle, for example, right angles or an angle determined by an object to be measured. Therefore, the probe needs to be bent or maintained straightly, according to the shape of the fixing part. When the carbon nanotube is bent at the end of the cantilever (or at the tip of the end of the holder), the carbon nanotube has a reflex angle of more than 180° and an obtuse angle of less than 180°. The two directions referred to in the present invention are at least the obtuse angle side and reflex angle side at the portion at which the carbon nanotube is bent. When the carbon nanotube is not bent, the two directions are the carbon nanotube side and cantilever side when the carbon nanotube and the end of the cantilever are mutually brought into contact.

The metal layer (supporting joint part) on the obtuse angle side is a supporting layer to fix the carbon nanotube. It is required to improve the strength of the joining of the carbon nanotube to the cantilever.

The metal layer (pressing joint part) on the reflex angle side provides an effect of pressing the carbon nanotube against the cantilever and thereby maintaining the direction of the probe. The metal layer on the reflex angle side is preferably deposited after the metal layer on the obtuse angle side has been deposited. This is because if the probe is inclined in excess of a desired fixing angle by the force to maintain the deposited metal layer on the obtuse angle side, the inclination can be adjusted by the force to press the deposited metal layer on the reflex angle side. Furthermore, highly precious adjustment to an angle suitable for the object to be measured or the measurement mode is possible.

If an appropriate depositing condition is selected for the metal layer, the metal layer can be extended not only in the direction in which electron beams are radiated but also to its opposite side. Specifically, if the metal layers on the reflex angle side and obtuse angle side are deposited from a single arbitrary direction, a deposition structure having a cross section shape similar to the cross section of a pencil, in which the probe is a core and the outer coating is the metal layer, can be formed. The properly selected depositing condition makes it possible to provide a cantilever that can be manufactured easily with a high yield.

If the cantilever or holder end to which the carbon nanotube is fixed is a polyhedral cone, the carbon nanotube is fixed on edges or sides of the cone. When, for example, the carbon nanotube is fixed to a pyramid-shaped holder, the end of the carbon nanotube opposite to the side in contact with the sample is fixed to an edge or side and further fixed along edges or sides at several points until the end of the holder is reached. At the end of the holder, the carbon nanotube is bent so that an arbitrary angle with respect to the plane of the sample base is obtained. As the probe is more perpendicular to the plane of the sample base, the bottoms of deeper depressions can be measured. When the surface of a deep depression is measured, the probe is preferably perpendicular to the plane of the sample base or inclined at an angle of 3 degrees or less from the perpendicular direction.

If the probe is fixed at a constant angle of 90° or less, for example, 30°, from the perpendicular direction with respect to the plane of the sample base, an area near a boundary between the bottom of a groove or hole formed in the sample and the side wall of it as well as the side wall can be measured. The direction in which to incline the probe is adjusted forward, backward, rightward, or leftward as viewed in the direction in which the probe proceeds on the sample, according to the surface shape of the sample. If the probe is inclined forward, backward, rightward, or leftward as viewed in the progress direction, the boundary opposite to the direction of the inclination and the side wall can be clarified. If the sample has an overhang protruding on the top of the side wall, when the probe is fixed at an angle and an appropriate approach direction is set for the cantilever, the overhang can also be measured.

The metal layer is formed by depositing one of the various metal compounds described above. When tungsten is used, the carbon nanotube and cantilever are mutually brought into contact and a gas generated by heating and evaporating W(CO)₆ or WF₂ is supplied into a sample chamber, with a high degree of vacuum, of a scanning probe microscope. The W(CO)₆ or WF₂ gas is then emitted to a portion near the contact part by using a nozzle to form an atmosphere of the gas near the contact part. Electron beams are radiated to the contact part to decompose the gas. The precipitated tungsten is finally deposited on the contact part, which is an area to which to radiate.

To increase the strength of the carbon nanotube, the strength of electron beams used to decompose the gas is preferably set to within a fixed range, thereby enabling a metal layer to extend up to the back of the carbon nanotube and deposited.

The electron beam strength is adjusted by the accelerating voltage and total current of the electron beam to be radiated. As the accelerating voltage is increased, the deposition of the metal layer largely deviates toward the beam radiating side, lessening an amount by which the metal layer extends to the back of the carbon nanotube. The accelerating voltage is preferably 15 kV or less. In addition, as the total current is increased, more things are likely to be deposited. To reduce the amount of contaminants deposited and assure a metal component content of 70% or more to form a metal layer having a sufficient strength, the total current is preferably 20 μA or less.

The metal layer has a thickness enough to fix the carbon nanotube. To prevent a buckle, the metal layer preferably has a thickness at least twice the radius of the carbon nanotube. If the radius of the carbon nanotube is 5 nm, for example, the thickness of the metal layer is preferably 10 nm or more. As a result, a metal layer surrounds the carbon nanotube with a diameter of 10 nm; the entire outer diameter is preferably three times (30 nm) or more the diameter of the carbon nanotube. For the height of the metal layer, it must be deposited so that the exposed range of the carbon nanotube is narrowed. The metal layer is preferably deposited so that the carbon nanotube is held almost at the center. If the position of the carbon nanotube is deviated, the metal layer is highly likely to be destructed from a thin metal layer part on the carbon nanotube.

Next, the use of the cantilever on a measuring apparatus will be described. The cantilever is fixed to a position at which the sample base for fixing a sample to the measuring apparatus and the probe face each other. The measuring apparatus has a driving mechanism that moves the sample base, the cantilever, or both so that they are brought close to each other or separated.

With a measuring apparatus such as an AFM, the cantilever is brought close to the sample until a load for pressing the cantilever against the sample (approach load) is reached. Even when the probe touches the sample, the cantilever is still pressed against the sample. As the approach load is increased, the cantilever functions as a leaf spring and warps. The amount of warp, the displacement of the base, and other factors are detected by a detector. When a value equal to a preset condition (with a preset approach load condition taken into consideration) is reached, a signal fed back from the detector stops the cantilever from being pressed.

A measuring apparatus that uses the cantilever, for example, obtains information about the height direction. If the carbon nanotube buckles or causes different bends at different times, the carbon nanotube fixing side (free end) of the cantilever sinks more than necessary, changing the height of the carbon nanotube fixing side of the cantilever (free end) relative to the sample surface. As a result, detected information about the height direction includes error, impairing the reliability of the obtained information.

To conduct accurate measurement, the carbon nanotube must be kept in a fixed state under a preset constant approach load. When the carbon nanotube is pressed against the sample several times, for example, if a fixed state (curved state, straight state, etc.) is assured for each contact, the correct surface state can be detected.

With the bottom of the carbon nanotube in contact with the sample, the approach load is applied to the carbon nanotube from the base through the cantilever, and a compressive stress is generated. When the approach load reaches the value of the buckle load of the carbon nanotube, the carbon nanotube can no longer maintain the fixed state and abruptly bends in the horizontal direction, that is, buckles. In most buckles of the carbon nanotube, excessive stress occurs in the horizontal direction when a slip occurs on the sample surface with which the end of the probe touches and the root, which is fixed to the cantilever, of the carbon nanotube buckles and then bends, or the middle part of the carbon nanotube buckles without a slip.

As described above, the approach load of the cantilever must be equal to or greater than a constant value. This requires that the buckle resistance and the strength against bends be high. Since the buckle resistance and the strength against bends are proportional to the fourth power of a thickness, buckles and bends can be avoided by enlarging the diameter of the carbon nanotube. However, a thick carbon nanotube is an obstacle to a goal to improve a spatial resolution by taking advantage of the fact that a carbon nanotube is thin. Since the buckle resistance and the strength against bends are inversely proportional to the square of a length (the longer the carbon nanotube is, the smaller the buckle resistance and the strength against bends are), buckles and bends can be avoided by shortening the carbon nanotube.

With the cantilever in the present invention, an exposed part on the carbon nanotube, which is used as a probe, is narrowed by depositing metal layers. In the manufacturing of a cantilever, there may be a process to cut the carbon nanotube to a desired length by, for example, applying a pulse voltage or passing current, but it is difficult to cut the carbon nanotube with high precision. A carbon nanotube with a stress lower than a desired buckle limit may be selected by chance, resulting in a low yield. When a metal layer is deposited thickly in the range in which the carbon nanotube is fixed with the metal layer as described above, the exposed range can be narrowed and thereby the length of the probe can be adjusted.

The present invention was devised by finding the fact that the hardness of a hetero carbon nanotube is higher than the hardness of a non-hetero carbon nanotube and therefore the hetero carbon nanotube can be applied to a contact-type cantilever. The hardness of the hetero carbon nanotube was remarkably improved by doping nitrogen or boron into the carbon nanotube.

In the carbon nanotube into which nitrogen or boron is doped, carbon in the carbon nanotube is replaced by nitrogen or boron, as described in Patent Document 1. The carbon nanotube including nitrogen can be manufactured by allowing a mixed gas of C₂H₂ and N₂ to flow to a carbon nanotube by chemical vapor deposition (CVD). The carbon nanotube including boron can be manufactured by arch discharging.

The content of nitrogen or boron is 5 atomic percent or less, preferably in the range of 2 to 5 atomic percent. When the content is within this range, the stiffness of the carbon nanotube can be increased with its properties maintained.

As a reason why the hardness of the hetero carbon nanotube is high, it is assumed that since the atomic radius of nitrogen or boron atoms, which are placed in the carbon atom positions by being substituted, differs from the atomic radius of carbon, stress is caused in the six-member or five-member ring structure. It is assumed that since the hardness is increased, even when the probe is pressed against the sample surface with a pressing force of 20 nN, which is the ordinary pressing load of the cantilever, the probe does not warp. Since warp of the probe is suppressed, the displacement of the cantilever directly matches the displacement of the sample surface, producing accurate images. When the pressing force is higher than 20 nN, the probe is likely to be broken. Even when the probe is broken, the carbon nanotube is still a tube having a constant thickness. Therefore, the tube diameter remains unchanged and no image failure occurs. When breakage occurs repeatedly, however, the life of the probe is shortened.

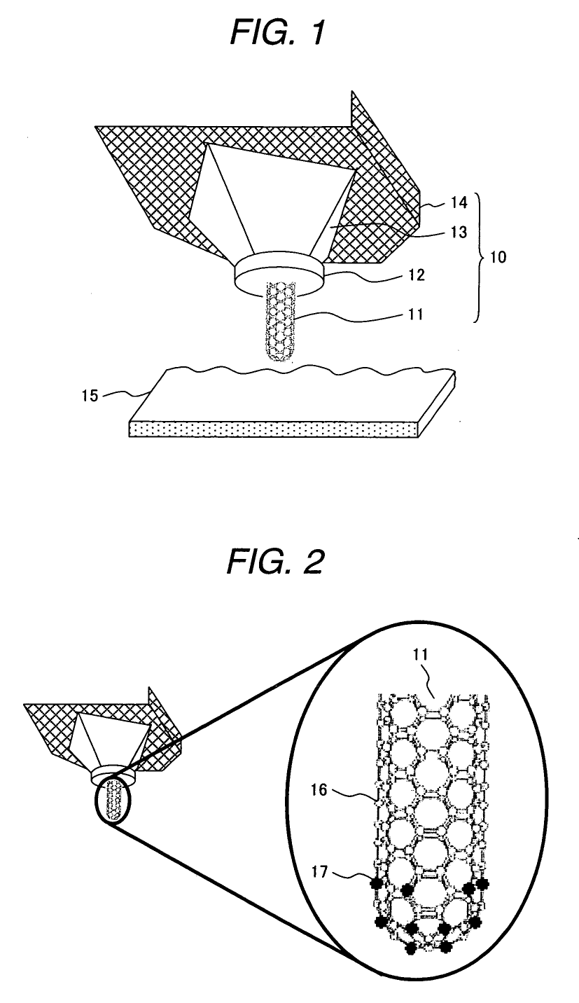

FIG. 1 is a perspective view of a cantilever according to an embodiment of the present invention. The cantilever 10 comprises a probe 11 formed by use of a hetero carbon nanotube, a beam 14, and a probe holding part for fixing the probe 11 to the beam 14. In the present embodiment, the probe holding part comprises a tungsten-deposited layer 12 and a pyramid part 13. The cantilever 10 is disposed so that the probe 11 is almost perpendicular to the surface of a sample base 15 of a probe microscope. After the probe 11 is brought into contact with the sample on the sample base 15 by the pressing load applied by the probe microscope, the beam 14 bends in proportion to the pressing load. Under this condition, operation is performed. To obtain accurate image data, under an increased pressing load of the cantilever 10, the probe 11 needs to be capable of maintaining high stiffness and allow only the beam 14 to bend.

FIG. 2 is a schematic diagram showing an atom array of the probe 11 of a hetero carbon nanotube. The carbon nanotube has an array in which some positions of carbon atoms 16 are replaced by boron or nitrogen 17. Since the boron or nitrogen 17 is substituted for carbon atoms 16, stress due to a difference in atomic radius is applied to the carbon nanotube and its hardness increases, improving the stiffness. In general, as described above, the boron-doped carbon nanotube is manufactured by arc discharging and the nitrogen-doped carbon nanotube is manufactured by CVD.

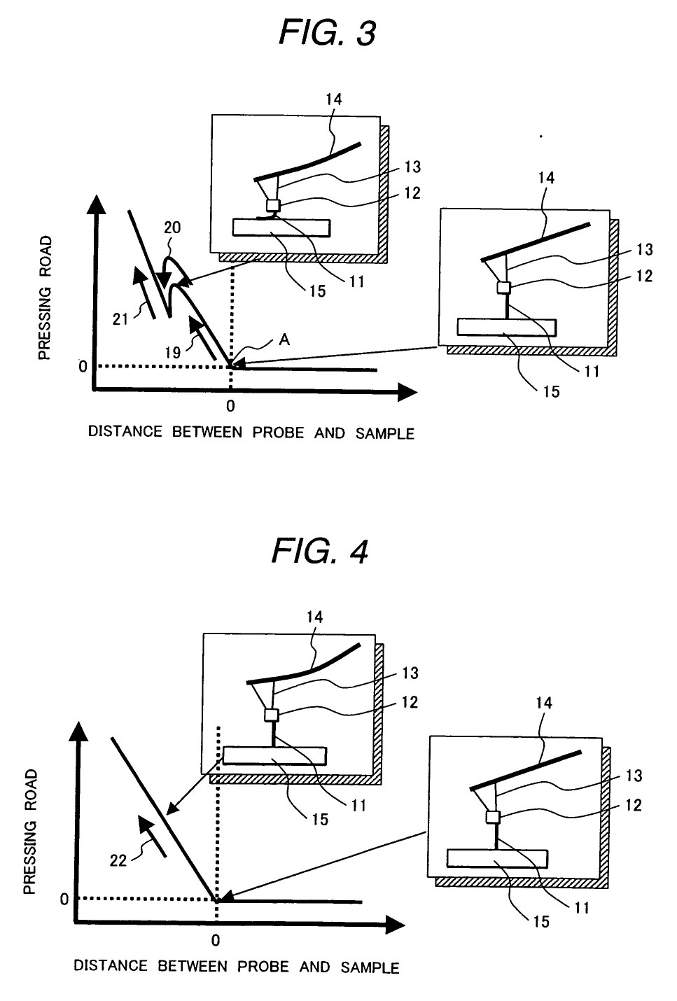

FIG. 3 shows a force curve when a probe that warps as the result of a cantilever being pressed against the surface of a sample is used. The horizontal axis indicates the distance between the probe 11 and the sample on the sample base 15, and the vertical axis indicates the pressing load. The probe 11 of the cantilever approaches and then touches the sample on the sample base 15 while a state in which there is no pressing load is kept. The probe 11 does not warp at a moment when the probe 11 touches the sample on the sample base 15 and there is no bend on the beam 14, as shown in point A and the small schematic figure superimposed on the right side in FIG. 3. When a pressing load is then applied to the probe 11, the beam 14, which has been straight, begins to bend in proportion to the pressing load as shown arrow 19 and the small schematic figure superimposed on the left side in FIG. 3. The bend of the beam 14 is fed back to the pressing load. The distance after the probe 11 has touched the sample on the sample base 15 is prolonged in the negative direction according to arrow 19 as the pressing load is increased. If the distance reaches a point at which an image failure will occur, however, the probe 11 warps due to a too large pressing load. The bend of the beam 14 is then mitigated and an apparent pressing load is reduced, as indicated by arrow 20. When the pressing load is further increased, the probe 11 no longer warps, and the pressing load including a resistance of the warp of the probe 11 increases in proportion to the distance after the contact, as indicated by arrow 21. In a method in which the beam 14 is used for detection in the height direction, therefore, inaccurate measurement is performed due to an effect by the warp of the probe 11, causing an image failure.

FIG. 4 shows a force curve when a probe does not warp is used. Since the probe 11 into which boron or nitrogen is doped is used, the stiffness of the probe 11 is increased. When measurement for obtaining a force curve as in FIG. 3 is performed, therefore, a normal image is obtained without an image failure. The measurement method is the same as in FIG. 3. The probe 11 approaches and then touches a sample on the sample base 15 while a state in which there is no pressing load is kept. When a pressing load is then applied to the probe 11, the beam 14, which has been straight, begins to bend in proportion to the pressing load, according to the distance after the probe has touched the sample on the sample base 15. There is no warp on the probe 11. The bend of the beam 14 is detected by a detector and fed back to the pressing load. Therefore, the distance after the touch is prolonged in the negative direction as indicated by arrow 19 as the pressing load is increased. This prevents an image failure.

### FIRST EMBODIMENT

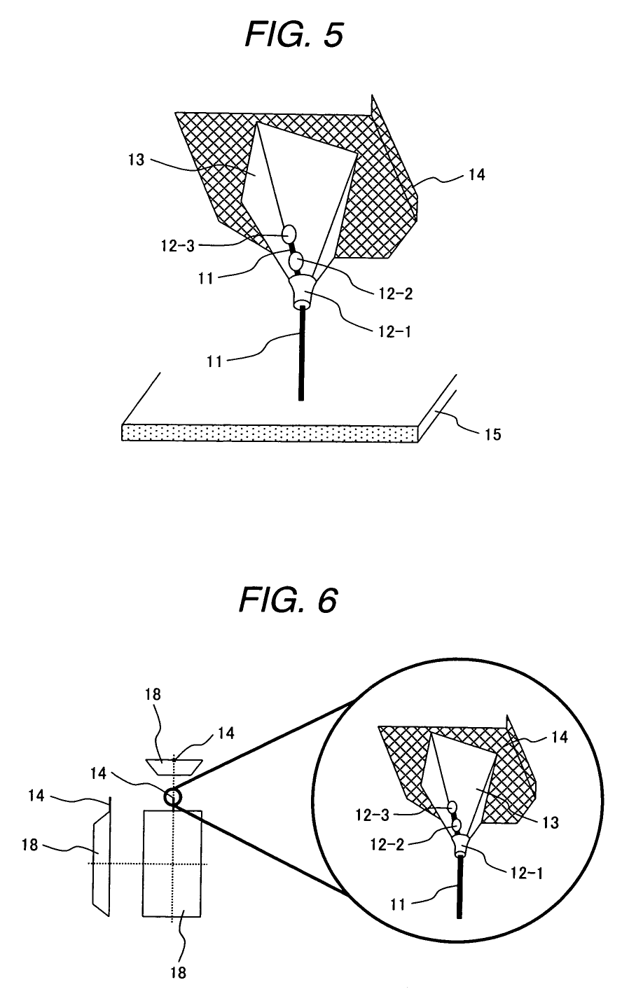

In a first embodiment of the present invention shown in FIGS. 5 to 7, a single carbon nanotube probe 11 is fixed at an end of a holder 13 with a metal layer. FIG. 5 is a perspective view of the probe of the inventive cantilever. FIG. 6 generally shows the cantilever including the cantilever probe shown in FIG. 5. As shown in FIG. 6, the cantilever has a chip, which comprises a carbon nanotube probe 11, end joint layer 12-1, middle joint layer 12-2, root joint layer 12-3, and holder 13, and also includes a base 18; the chip is provided at one end (free end) of the beam 14 and the base 18 is disposed at the other end (fixed end). The middle joint layer 12-2 and root joint layer 12-3, which are metal layers, are used as fixing layers for fixing the probe 11 to the holder 13.

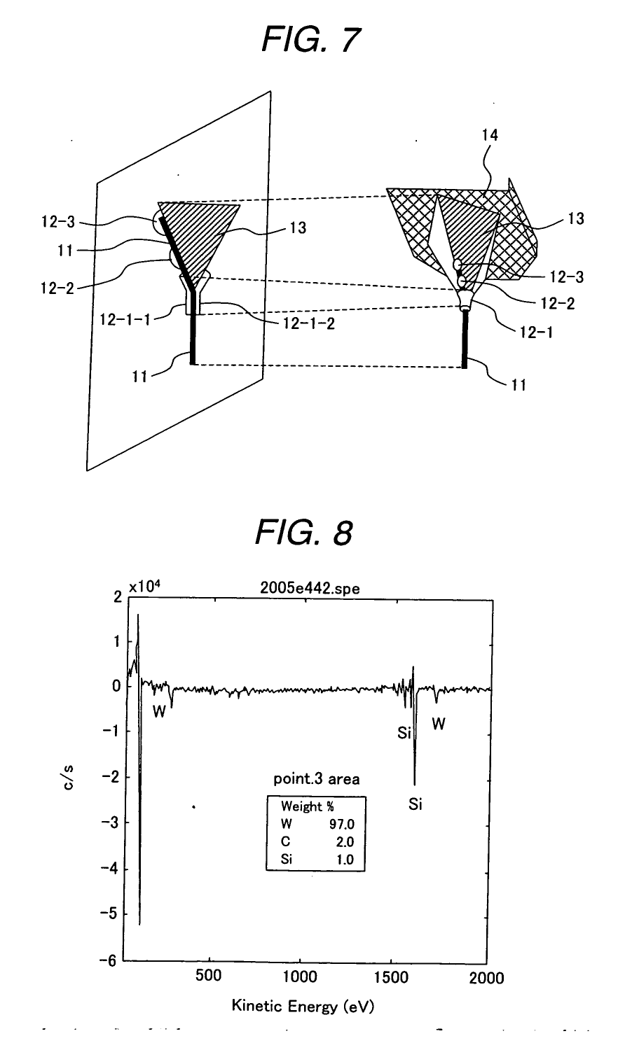

FIG. 7 is a cross-sectional view of the probe shown in FIG. 5. As shown in FIG. 7, the end joint layer 12-1 is separated into a supporting joint layer 12-1-1 on the obtuse angle side and a pressing joint layer 12-1-2 on the reflex angle side, according to their effects. As with the joint layers 12-2 and 12-3, the supporting joint layer 12-1-1 has an effect to fix the probe 11 to the holder 13. The pressing joint layer 12-1-2 has an effect to press back the carbon nanotube that will return to the straight state. The carbon nanotube probe 11 is fixed so that it is almost perpendicular to a plane of the sample base 15.

The probe 11 may not be parallel to the pressing direction or the tip of the probe 11 may slip. When this happens, the carbon nanotube bends without a buckle resistance, according to the approach load. Since the direction in which the carbon nanotube probe 11 extends straightly is almost perpendicular to the plane of the sample base 15, however, the slip is particularly reduced.

To provide an effect to prevent a slip and incline the probe 11, an appropriate angle by which the probe 11 is inclined is 5° or less relative to the vertical direction and preferably 2.5° or less. The friction resistances of most carbon nanotube probes 11 against the surface of a sample are 1 nN or more. The load applied to the carbon nanotube probe 11 in the slip direction is 0.04362 (sin 2.5°) times the approach load when the inclination angle is 2.5° and 0.08716 (sin 5°) at an angle of 5°, indicating the load at 2.5° is about half the load at 5°. When, for example, the approach load is 20 nN, the load of a horizontal slip is 0.8724 nN at 2.5° and 1.7432 nN at 5°. If the friction resistance of the carbon nanotube probe 11 is 1.0 nN or less, a slip does not occur at 2.5° but occurs at 5°. It can be thought that a probe can be manufactured that can be used on most apparatuses with less slips if the angle by which the probe 11 is inclined is 5° or less.

As described above, the load in the slip direction depends on the approach load and the angle by which the probe 11 is inclined, so the approach load is preferably preset to less than a load at which a slip occurs. However, the approach load must not be preset to a value that is too low to detect with the load detection precision specific to the measuring apparatus.

The carbon nanotube probe 11 was fixed along an edge of the holder 13 by forming the root joint layer 12-3, middle joint layer 12-2, and end joint layer 12-1 in that order. The end joint layer 12-1 was formed by depositing metal layers from two directions. In this embodiment, the carbon nanotube probe 11 was fixed along the holder 13 by punctiform metal layers at three points. However, this arrangement can be changed according to the length of the carbon nanotube and the sizes of the metal layers. A plurality of carbon nanotubes may be used as a single batch.

In this embodiment, tungsten is used for the metal layers.

The tungsten compound gas used is W(CO)₆. Electron beams were radiated for about 15 seconds with an acceleration voltage of 10 V and an emission current of 12 μA. The holder 13 is made of silicon (Si) and machined into a pyramid shape. The thickness of the metal layer can be adjusted by changing a beam radiation time. A beam radiation time of 10 to 30 seconds is enough to achieve a sufficient fixing strength.

FIG. 8 shows an analysis result of gradients in the metal layer; the content of tungsten was 90% or more. Measured joint strength was sufficient for practical use. Tungsten in the metal layer was detected by a scanning Auger electronic spectroscopic analyzer (PH1700 from ULVAC-PHI) and mapping was performed to confirm the metal layer.

### FIRST COMPARISON EXAMPLE

The same apparatus as in the first embodiment was created, but metal layers were formed from only one direction.

Tungsten was doped in the metal layers as described above. The carbon nanotube was fixed in the same way, but the end joint layer was formed from only one direction.

The end of the carbon nanotube probe 11 was cut by applying a pulse voltage.

The cantilever in the first comparison example was operated within a scanning electron microscope (SEM) that was used to deposit the metal layers. An Au wire, which is highly resistive to corrosion and superior in conductivity, was used as an observation sample. An end of the Au wire was cut with nippers. The cross section of the cut part was wedge-like due to the cutting. A plane part of a wedge-like side was used as a sample plane. Part of the area excluding the sample plane of the Au wire was bent at right angles so that the sample plane and probe 11 faced each other.

To observe measurement status, the cantilever was rotated 90° and disposed with the beam 14 kept horizontal. It was operated at a position where an image similar to the projected figure in FIG. 7 could be observed with the SEM.

The sample base 15 was moved to bring a flat surface of the Au wire close to the probe 11 with the cantilever left stationary. Even after the Au wire touched the probe 11, the sample base 15 was further moved until a load equivalent to a force equivalent to an approach load on an actual apparatus was obtained. In the middle of measurement, a buckle of the carbon nanotube was observed.

### SECOND COMPARISON EXAMPLE

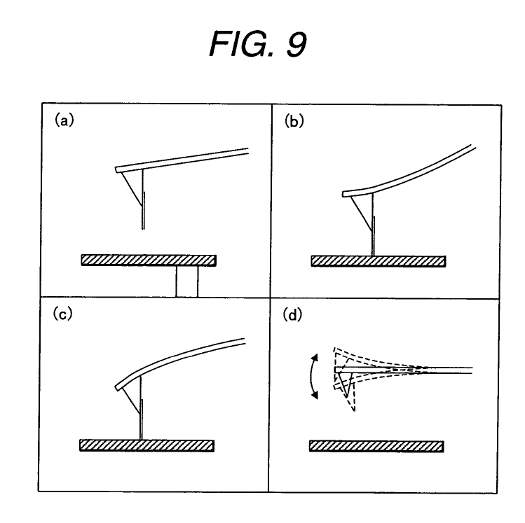

An apparatus similar to the one indicated in the first embodiment was created, in which conventional hydrocarbon layers (contamination) substituted for the metal layers were joined. The carbon nanotube probe 11 was released while the apparatus was being used. FIGS. 9A to 9D illustrate the states of the cantilever in the second comparison example that was used on an actual apparatus. An Au wire was used as a sample.

FIG. 9A shows a process in which the cantilever is approaching. The carbon nanotube probe 11 is near the surface of the Au wire but not in contact with the surface of the Au wire.

FIG. 9B shows a process in which the carbon nanotube probe 11 touches the surface of the Au wire and is pressed until an initially set approach load is reached.

FIG. 9C shows a process in which the approach load is reached and then the cantilever is released. Unlike the contact process, the end of the carbon nanotube probe 11 is in contact with the sample while attracting the cantilever by a force which is supposed to be an attracting force generated by static electricity.

FIG. 9D shows an instant at which the carbon nanotube probe 11 is released from the surface of the Au wire. Since the cantilever 10 has been attracted by the attraction force, a restoration force is applied to the cantilever 10 immediately when it is released and the cantilever 10 vibrates vigorously. In observation with the SEM, the image of the probe was unclear due to the vibration. The carbon nanotube probe 11 fell out due to the vibration at the time of release. Tear was observed on the joint layers after the probe 11 fell out.

When a metal layer in which tungsten was doped was deposited, the carbon nanotube was not attracted.

The above phenomenon may be attributable to charges, so the carbon nanotube is supposed to have dropped due to the discharging of static electricity. Since the inventive carbon nanotube is fixed by metal, it can be considered that the carbon nanotube probe 11 is not charged and thereby the attraction and destruction described above can be avoided. Therefore, the product can be expected to have an improved durability and prolonged life. High measurement precision can also be expected.

### SECOND EMBODIMENT

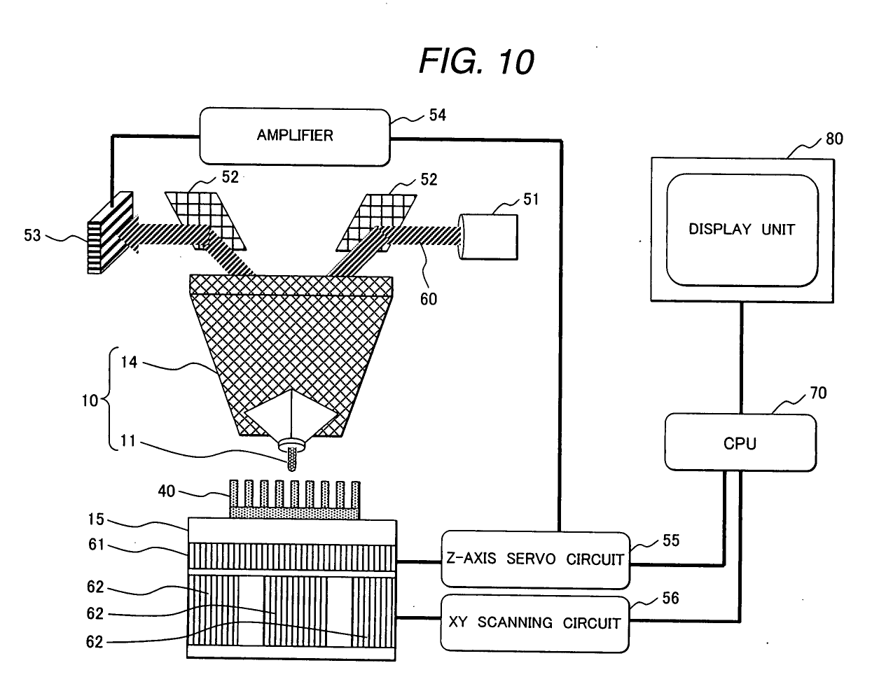

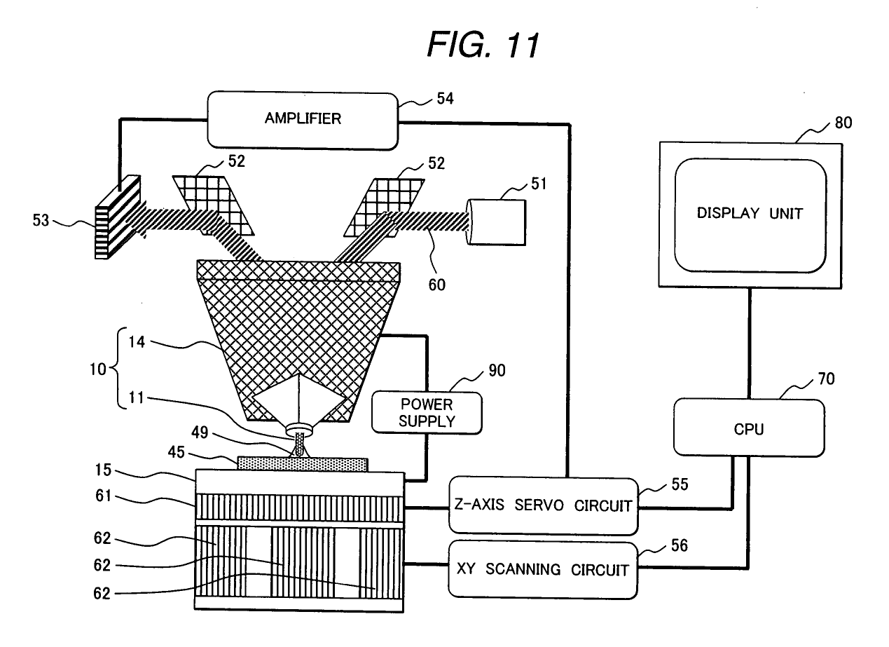

An embodiment of an LSI inspecting apparatus having the inventive cantilever that uses a carbon nanotube including heteroatoms will be described with reference to FIG. 10. The LSI inspecting apparatus in this embodiment has a cantilever 10, which comprises a probe 11 formed by use of a hetero carbon nanotube and a beam 14 that supports the probe 11, and a contact detector for detecting that the cantilever 10 touches an LSI chip under test on a sample base 15. The contact detector comprises a laser source 51, a laser reflecting mirror 52, a light detector 53, and an amplifier 54 for amplifying an optical signal detected by the light detector 53. The apparatus further includes a Z-axis servo circuit 55 for feeding back a signal from the amplifier 54, a piezoelectric device 61 for adjusting the position of the sample base 15 in the height direction by use of a signal from the Z-axis servo circuit 55, an XY scanning circuit 56 necessary for obtaining two-dimensional surface information, a piezoelectric circuit 62 for adjusting the position of the sample base 15 in the horizontal direction by use of a signal from the XY scanning circuit 56, a CPU 70 for receiving signals from the Z-axis servo circuit 55 and XY scanning circuit 56, and a display unit 80 for displaying an image according to the signals received by the CPU 70.

An LSI chip 40 under test is placed on the sample base 15. The LSI chip 40 is then moved by the Z-axis servo circuit 55 and XY scanning circuit 56 to a position underneath the probe 11. To detect that the LSI chip 40 have touched the probe 11, it suffices to transfer to the CPU 70 information indicating the beam 14, which supports the probe 11, is bent. The bend of the beam 14 is extremely small. To detect the bend, laser light 60 emitted from the laser source 51 disposed at one end is directed to the beam 14. The reflected laser light is detected by the light detector 53 disposed at the other end. A longer light path is more superior, but the length is restricted by the structure of the light detector. The LSI chip 40 is inspected with a pressing force minimized within the range in which the bend of the beam 14 detected after the LSI chip 40 has touched the probe 11 can be maintained. Image information about surface roughness of the LSI chip 40 can then be obtained with high precision.

### THIRD EMBODIMENT

An embodiment of a lithography apparatus having the inventive cantilever will be described with reference to FIG. 11. The lithography apparatus in this embodiment has substantially the same structure as the LSI inspecting apparatus shown in FIG. 10, except that a lithography power supply 90 for electrically connecting the cantilever 10 to the sample base 15 is provided. The hetero cantilever 10 is characterized in that it is hydrophilic. The use of the property enables the cantilever 10 to be employed as the probe 11 of the lithography apparatus. When the probe 11 of the cantilever 10 is brought into contact with a sample 45 under test by the lithography apparatus, a part brought into contact is covered with absorbed water 49. When current is passed through the absorbed water 49, the sample 45 is anodized, making lithographing possible.

What is claimed is:

1. A cantilever having a base fixed to an inspecting apparatus, a beam protruding from the base, and a probe fixed to an end of the beam, wherein:
the probe is formed by use of a carbon nanotube; and the probe is fixed by metal layers from at least two directions when the cantilever is operated, the probe protrudes in a direction in which a sample is fixed.

2. A cantilever according to claim 1, wherein the probe is formed by use of a hetero carbon nanotube.

3. A cantilever according to claim 1, wherein the probe is formed by use of a carbon nanotube including boron or nitrogen.

4. A cantilever according to claim 3, wherein the content of boron or nitrogen is 2 to 5 atomic percent.

5. A cantilever according to claim 1, wherein each of the metal layers includes tungsten the content thereof is 70 percent or more.

6. A cantilever according to claim 5, wherein a main constituent of the metal layer is a decomposition product of tungsten hexacarbonyl or tungsten fluoride.

7. A cantilever according to claim 1, further comprising a holder fixed near an end of a protruding part of the beam, and the probe is fixed to the holder.

8. A cantilever according to claim 7, wherein the holder has a shape like a circular done, a polyhedral cone, or a cylindrical column, or has a shape like a circular-cone, a polyhedral cone, or a cylindrical column with a tip thereof is shaped into a needle.

9. A cantilever according to claim 7, wherein the carbon nanotube is fixed at least near the end of the holder and bent at the position where the carbon nanotube is fixed.

10. A cantilever according to claim 1, wherein the probe is fixed in a direction perpendicular to a plane of a sample base for fixing a sample or fixed at an angle of 5° or less relative to the perpendicular direction.

11. A cantilever according to claim 7, wherein the holder has a shape like a polyhedral cone, and the carbon nanotube is fixed along an edge of the holder having the shape like a polyhedral cone.

12. A cantilever according to claim 1, further comprising a holder with a shape like a polyhedral cone formed by machining a part near the end of a protruding part of the beam, and the probe is fixed to the holder.

13. A cantilever having a base fixed to an inspecting apparatus, a beam protruding from the base, a holder attached to an end of the beam, and a probe fixed to an end of the holder, wherein:
the probe is formed by use of a carbon nanotube;
the probe has metal layers that fix the probe at least two points when the cantilever is operated, the probe protrudes in a direction in which a sample is fixed; and metal layers of the metal layers nearest to the end of the holder are formed from two directions.

14. A cantilever according to claim 1, each of the metal layers includes any one of tungsten, platinum, aurum, aluminum, copper, and molybdenum.
